(19) United States
(12) Patent Application Publication
(10) Pub. No.: US 2020/0406485 A1
(43) Pub. Date: Dec. 31, 2020

(54) SAFETY RAZOR SHAVING SYSTEM

(71) Applicant: BEIERSDORF AG, Hamburg (DE)

(72) Inventors: Alexander KRUEMKE, Hamburg (DE); Peter MAURER, Neumuenster (DE); Michaela KOHUT, Hamburg (DE); Frank HETZEL, Welle (DE); Jelte STEUR, Oudehaske (NL); Arif VEENDIJK, Assen (NL); Johannes Rogier DE VRIND, Haren (NL); Patje SANDER, Groningen (NL)

(21) Appl. No.: 16/979,977

(22) PCT Filed: Dec. 18, 2018
(86) PCT No.: PCT/EP2018/085380

§ 371 Date: Sep. 11, 2020

(30) Foreign Application Priority Data
Mar. 13, 2018 (DE) 10 2018 105 822.5

(51) Int. Cl. B26B 21/22; B26B 21/52; B26B 21/40

(52) U.S. Cl. CPC B26B 21/225; B26B 21/522; B26B 21/4018; B26B 21/521

(57) ABSTRACT

A safety razor shaving system, comprising: a handle having a handle connecting structure; and a replaceable razor cartridge having a cartridge connecting structure; wherein the handle connecting structure comprises two arms, each arm having a proximal end connected to the handle and a free distal end having a pin extending away from the pin of the other arm; and wherein the cartridge connecting structure comprises two through holes, each through hole configured to accommodate one of the pins and one of two end portions of a resiliently flexible clip, the two end portions of the resiliently flexible clip configured to eject the two pins from the through holes when a user-applied pinching force is applied to opposite sides of the clip.

### FIELD

The invention relates to safety shaving razor systems and, more particularly, to structures for connecting a replaceable blade cartridge to a handle of such safety razor shaving systems.

### BACKGROUND

Safety razor shaving systems typically comprise a handle and a replaceable blade cartridge (often also called a disposable cartridge or simply a cartridge) in which a plurality of blades are arranged in parallel between a guard and a cap, with a connecting structure (or connecting structures) for releasably securing the cartridge to the handle, release of the cartridge from the handle being effected by a user-actuated mechanism such as a button on the handle. To allow greater handle design flexibility, it would be desirable to provide a shaving razor system in which the release mechanism is provided on the cartridge rather than on the handle.

### SUMMARY

One embodiment of the present invention provides a safety razor shaving system, comprising: a handle having a handle connecting structure; and a replaceable razor cartridge having a cartridge connecting structure; wherein the handle connecting structure comprises two arms, each arm having a proximal end connected to the handle and a free distal end having a pin extending away from the pin of the other arm; and wherein the cartridge connecting structure comprises two through holes, each through hole configured to accommodate one of the pins and one of two end portions of a resiliently flexible clip, the two end portions of the resiliently flexible clip configured to eject the two pins from the through holes when a user-applied pinching force is applied to opposite sides of the clip.

By providing a user-actuated release member in the cartridge and a simple connecting structure, a range of different handle designs can be implemented with relative ease to suit individual requirements and tastes in terms of ergonomics. The overall design of the safety razor shaving system is simplified by integrating the pivot and release mechanisms. The opposite sides of the clip are those positioned

In one embodiment, the resiliently flexible clip has a pair of U-shaped portions that are joined by a base portion that extends parallel to the plurality of elongate blades. The two end portions of the resiliently flexible clip can extend toward each other from the U-shaped portions. The U-shaped portions provide a resilient bias opposing the pinching force, so that the two end portions of the resiliently flexible clip spring back to their starting position when the pinching force is removed.

In one embodiment, at least the base portion and the two end portions of the resiliently flexible clip are located within the replaceable razor cartridge. This reduces to a minimum the impact on shaving performance. The base portion can be located between the elongate blades and a front-most portion of the cartridge and the two end portions can be located between the elongate blades and a rear-most portion of the cartridge, e.g., in the guard and the cap respectively.

The U-shaped portions can also be housed within the body of the cartridge, for example at the ends of the blades so that they are flush with the opposite sides of the replaceable razor cartridge. However, in one embodiment, the pair of U-shaped portions extend out from the opposite sides of the replaceable razor cartridge. This enables the U-shaped portions to be more easily actuated by the user. The likelihood of accidental release is minimised by the fact that in order to eject the handle connecting structure the pinching force is applied from both sides.

In one embodiment, the two pins have a recess configured to engage a complementary protrusion of the end portions of the resiliently flexible clip. Alternatively, the two pins can have a protrusion configured to engage a complementary recess of the end portions of the resiliently flexible clip. This is a simple structure to allow the two pieces to fit one another. A further alternative is simply to provide flat surfaces.

To allow easier insertion of the handle connecting structure into the cartridge connecting structure, the cartridge can have guide surfaces configured to guide the pins of the handle connecting structure into the through holes.

These and other features and advantages will be apparent from a reading of the following detailed description and a review of the associated drawings. It is to be understood that both the foregoing general description and the following detailed description are explanatory only and are not restrictive of the invention as claimed.

One embodiment of the present invention provides a replaceable razor cartridge for a safety razor shaving system including a handle having a handle connecting structure having two arms, each arm having a proximal end connected to the handle and a free distal end having a pin extending away from the pin of the other arm, the replaceable razor cartridge comprising: a guard, a cap, and one or more elongate blades disposed in parallel between the guard and the cap; a resiliently flexible clip; and a cartridge connecting structure comprising two through holes, each through hole configured to accommodate one of the pins and one of two end portions of the resiliently flexible clip, the two end portions of the resiliently flexible clip configured to eject the two pins from the through holes when a user-applied pinching force is applied to opposite sides of the clip.

In any of the aforementioned safety razor system embodiments, the handle can comprise an underneath surface portion facing the skin of the user in use; a front surface portion facing in the opposite direction from the shaving direction in use; a rear surface portion facing in the shaving direction in use; a top surface portion and side surface portions, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The “chunky” bulbous shapes of the handle allow a particularly flexible ergonomic handling, giving many varied gripping positions for the human hand and easy twisting of the handle within the grip to reach different angles. The handle can alternatively be defined in terms of its bulbous shape, as comprising a handle body and a handle connecting structure; wherein the handle body is bulbous in two orthogonal directions, widening away from an end surface towards the centre of the body. This definition applies to any of the aforementioned safety razor system embodiments.

Moreover this handle shape allows the handle to stand on a surface with the blade and any lubrapad of an attached blade unit suspended above the surface. This can help prevent blade corrosion. The handle can alternatively be defined in these terms as comprising a handle body with a substantially flat end surface and a side surface (to which the handle connecting structure is attached), wherein: when the flat end surface is in contact with a horizontal plane and the cartridge is connected to the handle via the cartridge connecting structure and the handle connecting structure, the safety razor is in a stable position of rest, the flat end surface forming the safety razor's only region of contact with the plane and elevating the cartridge above the plane. This definition applies to any of the aforementioned safety razor system embodiments.

These and other features and advantages will be apparent from a reading of the following detailed description and a review of the associated drawings. It is to be understood that both the foregoing general description and the following detailed description are explanatory only and are not restrictive of the invention as claimed.

### DESCRIPTION OF FIGURES

Embodiments will now be described by way of example with reference to the accompanying drawings in which:

FIG. 1 is perspective view of a safety razor shaving system, in accordance with an embodiment of the present invention.

FIG. 2 is a perspective view of the cartridge and part of the handle of the safety razor shaving system shown in FIG. 1, showing the handle connecting structure disconnected from the cartridge connecting structure.

FIG. 3 is a perspective view of part of the handle and the cartridge of the safety razor shaving system shown in FIG. 1, showing the handle connecting structure connected to the cartridge connecting structure.

FIG. 4 is a top view of part of the handle and the cartridge of the safety razor shaving system shown in FIG. 1, showing the handle connecting structure connected to the cartridge connecting structure.

FIG. 5 is a cross-sectional through the cartridge of the safety razor shaving system shown in FIG. 4.

FIG. 6 is perspective view of a safety razor shaving system, in accordance with another embodiment of the present invention.

FIGS. 7 to 9 are perspective views of the handle of the safety razor shaving systems shown in FIG. 6.

### DETAILED DESCRIPTION

This disclosure is generally concerned with connecting structures and release mechanisms that allow a replaceable blade cartridge to be connected and disconnected from a handle of a safety razor shaving system. As such, certain features of the replaceable blade cartridge, such as the blades, are not depicted in the figures. It will be appreciated, however, that these features form part of the safety razor shaving system described herein.

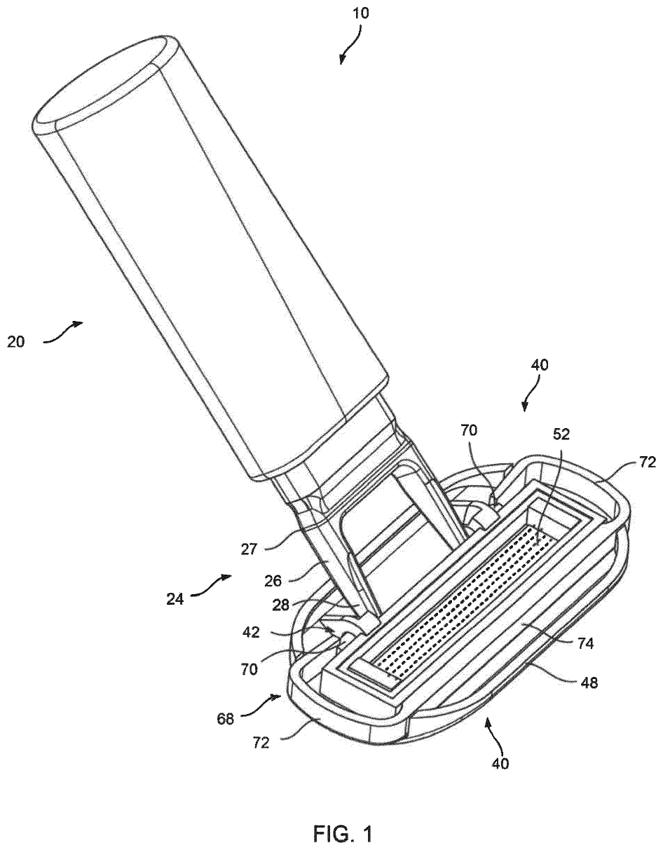

FIGS. 1 to 5 show a safety razor system 10 comprising a handle 20 and a replaceable blade cartridge 40.

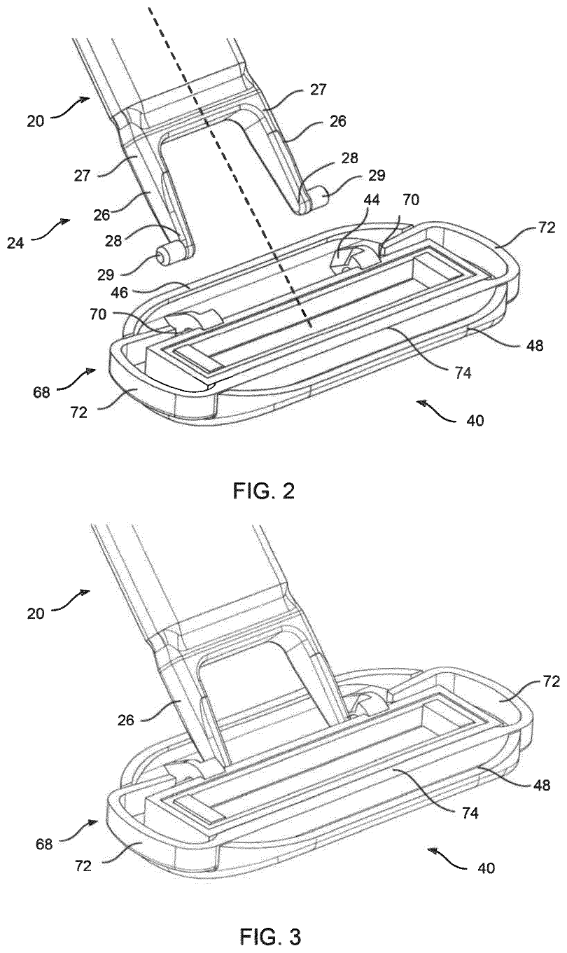

The handle 20 has a handle connecting structure 24 comprising a pair of arms 26 joined at one of their ends (the proximal ends) 27 by the main body (i.e., the grip) of the handle 20. Here, the pair of arms 26 extend generally parallel to each other, but curved arms or arms that are non-parallel to each other could be implemented alternatively. The free ends (distal ends) 28 of the arms 26 have respective pins 29 which extend away from each other, as best seen in FIG. 2.

The cartridge 40 has a guard 46, a cap 48, and one or more elongate blades disposed in parallel between the guard 46 and the cap 48. For example, the cartridge 40 can have two or more (for example, five) blades. A shaving aid, such as a lubricating strip, can be incorporated in one or both of the guard 46 and the cap 48. As noted above, certain features of the cartridge 40 are not depicted in the figures. However, the dashed lines in the figures represent the blades 52. The upper portion of the cartridge is also not depicted in FIGS. 1 to 5 to provide a better view of the clip 68. The expressions “in front of” and “to the rear of” the blades are used in relation to the shaving direction. That is, when the safety razor shaving system 10 is drawn across the skin in the shaving direction, the guard 46 is ahead of the blades in the shaving direction and the cap 48 is behind the blades in the shaving direction. The guard 46 and the cap 48 are connected by lateral side portions 41. The cartridge 40 includes a lower side and an upper side. The lower side of the cartridge 40 includes a skin-contacting surface of the guard 46 and a skin-contacting surface of the cap 48, and can therefore also be referred to as the skin-contacting side of the cartridge 40. The terms “upper” and “lower” are therefore used to define the sides of the cartridge 40 relative to the shaving surface.

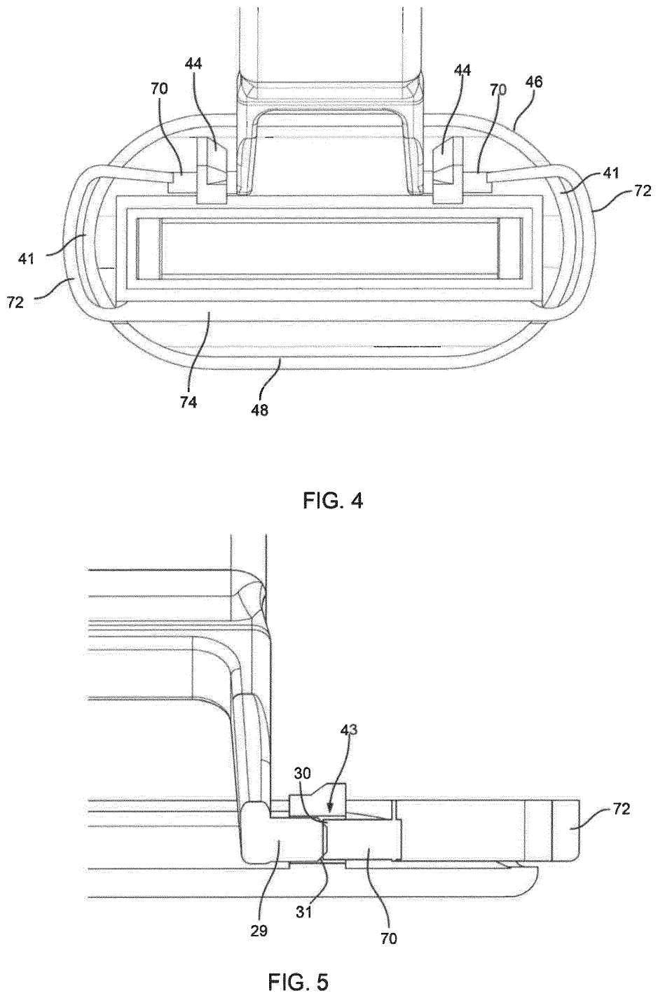

The cartridge 40 has a cartridge connecting structure 42 in the form of two through holes 43. When the handle connecting structure 24 and the cartridge connecting structure 42 are brought together along a connection axis (represented by a dashed line in FIG. 2), guide surfaces 44 of the cartridge 40 urge the pins 29 of the handle connecting structure 24 towards each other. This causes the arms 26, and more specifically their proximal ends 27, to flex inwards towards each other. Once the pins 29 are aligned with the inward facing openings of the through holes 43, the spring-like property of the arms 26 urges the pins 29 into the through holes 29. As is best seen in FIGS. 4 and 5, the through holes 43 accommodate the pins 26 approximately half way therein. Other positions are also possible of course. The round nature of the through holes 29 allows the handle connecting structure 24 to pivot therein. Alternatively, the handle connecting structure 24 could be connectable in a manner that does not allow pivoting, for example by using pins and complementary holes that are not round.

The outward facing openings of the through holes 43 are configured to receive two end portions 70 of a resiliently flexible clip 68. The clip 68 has a base portion 74, two end portions 70, and a pair of U-shaped (outwardly bowed) portions 72 that join the base portion 74 and the two end portions 70. As can be seen in FIG. 4, the base portion 74 and the two end portions 70 extend generally parallel to the elongate blades (generally perpendicular to the shaving direction), with the two end portions 70 extending toward each other and configured to be received and accommodated in the through holes 43 also approximately half way therein.

The base portion 74 and the two end portions 70 of the clip 68 are housed in the replaceable razor cartridge 40, with the base portion 74 located between the elongate blades and a front-most end of the cartridge 40, and with the two end portions 74 located between the elongate blades and a rear-most end of the cartridge 40. The upper portion of the cartridge 40, which, as noted above, is not depicted in the figures, can have the same outer perimeter (footprint area) as the bottom portion of the cartridge shown in FIG. 4, so that the U-shaped portions 72 extend out from the lateral side portions 41 of the cartridge 40. This makes them easy to actuate by the user. Alternatively, U-shaped portions can be provided which are flush with the surfaces of the lateral side portions 41 of the cartridge 40.

The U-shaped portion 72 can be wider than the shortest distance between the base portion 74 and the end portions 70 of the clip 68. This improves the spring properties of the clip 68. The clip 68 can be made of plastic, metal or other resilient materials.

The clip 68 functions as a release member. In particular, when the user applies a pinching force to the U-shaped portions 72, the two end portions 70 of the clip 68 are forced towards each other. This, in turn, urges the pins 29 towards each other so that the arms 26 of the handle connecting structure 24 flex inwards, and the pins 29 are ejected from the through holes 43. This releases the handle connecting structure 24 from the cartridge 40. The U-shaped portions 72 provide a resilient bias opposing the pinching force, so that the two end portions 70 spring back to their starting position (approximately half way in the through holes 43) when the pinching force is removed.

As can be seen in FIG. 5, the end portions 70 of the clip 68 have a recess 30 to receive a protrusion 31 formed on the pins 29 so as to provide better engagement. However, this configuration can be reversed with the end portions 70 of the clip 68 having a protrusion and the pins having a recess. A further alternative is simply to provide flat surfaces.

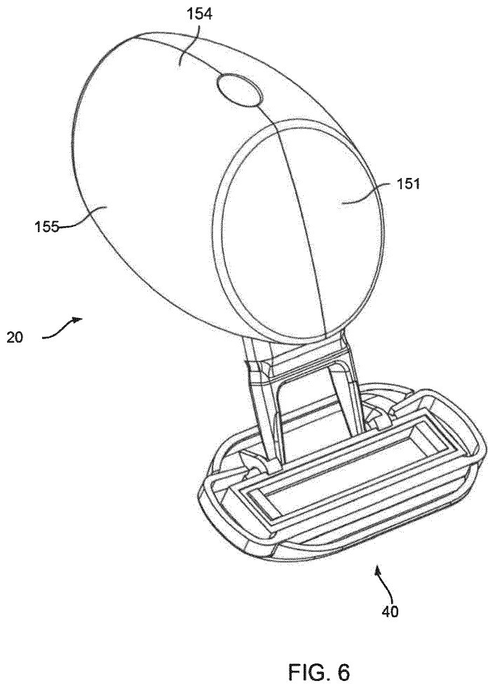

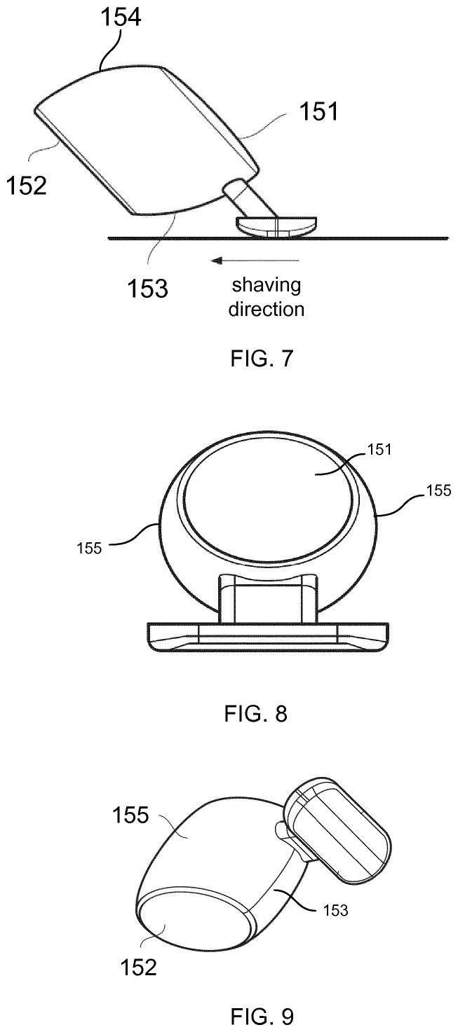

The handle depicted in FIGS. 1 to 5 is merely one of many different possible designs taken for illustration of the principle of the connecting structures. Indeed, a preferred handle that provides particularly flexible ergonomic handling (among other things) is shown in FIGS. 10 to 14. The connecting structures 24, 42 of the safety razor systems 10 shown in FIGS. 10 and 11 generally are the same as the connecting structures 24, 42 of the safety razor systems 10 shown in FIGS. 1 to 4 and FIGS. 5 to 8, respectively. They will therefore not be described again below.

The handle 20 of the safety razor system 10 shown in FIGS. 10 to 14 has a front surface portion 151, which is flat, a rear surface portion 152 which is also flat, a curved underneath surface portion 153 to which the handle connecting structure 24 is attached, a curved top surface portion 154 and curved side surface portions 155. These curved surface portions 155 together form a continuous smooth curved surface which is circular or spherical in cross section, but may vary in shape and size along its length between the front and rear of the handle. The handle 20 may be seen as a barrel-shape, for example, with slanted ends, or a similar ellipsoid barrel shape.

Similar to the terms “upper” and “lower” used previously, the terms “underneath” is used to describe features of the handle that are positioned on the skin-contacting side, and the term “top” is used to describe features of the handle that are positioned on a side opposite the underneath side. The terms “front”, “rear”, and “side(s)” are used herein with reference to the shaving direction, similar to the expressions “in front of” and “to the rear of” the blades used previously. In particular, the term “front” means facing the shaving direction, “rear” means facing away to the shaving direction, and “side(s)” mean to either side in the shaving direction. The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

The handle connecting structure 24 can simply fit into a recess in the underneath surface portion 153, where it is glued or otherwise affixed in place. Of course, the handle connecting structure could alternatively be provided outside or inside the handle body via another structure that may be on (and/or inside) the side surface, or on (and/or inside) the flat end surface and the side surface.

While specific embodiments have been illustrated and described, it will be apparent to those skilled in the art that various changes and modifications may be made without departing from the invention. Accordingly, it is intended that the appended claims be interpreted as covering all such changes and modifications as fall within the true spirit and scope of the invention.

The Summary and Abstract sections may set forth one or more but not all exemplary embodiments of the present invention as contemplated by the inventor(s), and thus are not intended to limit the present invention and the appended claims in any way.

The breadth and scope of the present invention should not be limited by any of the above-described exemplary embodiments, but should be defined only in accordance with the following claims and their equivalents.

### REFERENCE LIST

10 safety razor shaving system
20 handle
24 handle connecting structure
26 arms of the handle connecting structure
27 proximal ends of the arms
28 distal ends of the arms
29 pins of the distal ends
30 recess
31 protrusion
40 replaceable blade cartridge
41 lateral side portions of the blade cartridge
42 cartridge connecting structure
43 through holes of the cartridge connecting structure
44 guide surface
46 guard
48 cap
52 blade(s)
68 resiliently flexible clip
70 end portions of the flexible clip
72 U-shaped portions of the flexible clip
74 base portion of the flexible clip
151 front surface portion (of handle)
152 rear surface portion (of handle)
153 underneath surface portion (of handle)
154 top surface portion (of handle)
155 side portion(s) (of handle)

1.-8. (canceled)

9. A safety razor shaving system, wherein the system comprises:
a handle comprising a handle connecting structure; and
a replaceable razor cartridge comprising a cartridge connecting structure,
the handle connecting structure comprising two arms, each arm having a proximal end connected to the handle and a free distal end having a pin extending away from the pin of the other arm; and
the cartridge connecting structure comprising two through holes, each through hole configured to accommodate one of the pins and one of two end portions of a resiliently flexible clip, the two end portions of the resiliently flexible clip configured to eject the two pins from the through holes when a user-applied pinching force is applied to opposite sides of the clip.

10. The safety razor shaving system of claim 9, wherein the resiliently flexible clip comprises a pair of U-shaped portions joined by a base portion that extends parallel to a plurality of elongate blades.

11. The safety razor shaving system of claim 10, wherein the two end portions of the resiliently flexible clip extend toward each other from the U-shaped portions.

12. The safety razor shaving system of claim 9, wherein at least a base portion and the two end portions of the resiliently flexible clip are located within the replaceable razor cartridge.

13. The safety razor shaving system of claim 9, wherein the pair of U-shaped portions extend out from opposite lateral side portions of the replaceable razor cartridge.

14. The safety razor shaving system of claim 10, wherein the pair of U-shaped portions extend out from opposite lateral side portions of the replaceable razor cartridge.

15. The safety razor shaving system of claim 9, wherein the two pins comprise a recess, or a protrusion, configured to engage a complementary protrusion, or a complementary recess, of the end portions of the resiliently flexible clip.

16. The safety razor shaving system of claim 9, wherein the cartridge comprises guide surfaces configured to guide the pins of the handle connecting structure into the through holes.

17. A replaceable razor cartridge for a safety razor shaving system including a handle having a handle connecting structure having two arms, each arm comprising a proximal end connected to the handle and a free distal end comprising a pin extending away from the pin of the other arm, wherein the replaceable razor cartridge comprises:
a guard, a cap, and one or more elongate blades disposed in parallel between the guard and the cap;
a resiliently flexible clip; and
a cartridge connecting structure comprising two through holes, each through hole configured to accommodate one of the pins and one of two end portions of the resiliently flexible clip, the two end portions of the resiliently flexible clip configured to eject the two pins from the through holes when a user-applied pinching force is applied to opposite sides of the clip.

18. The replaceable razor cartridge of claim 17, wherein the two end portions of the resiliently flexible clip extend to each other from the U-shaped portions.

19. The replaceable razor cartridge of claim 17, wherein at least a base portion and the two end portions of the resiliently flexible clip are located within the replaceable razor cartridge.

20. The replaceable razor cartridge of claim 17, wherein the pair of U-shaped portions extend out from opposite lateral side portions of the replaceable razor cartridge.

21. The replaceable razor cartridge of claim 18, wherein the pair of U-shaped portions extend out from opposite lateral side portions of the replaceable razor cartridge.

22. The replaceable razor cartridge of claim 17, wherein the two pins comprise a recess, or a protrusion, configured to engage a complementary protrusion, or a complementary recess, of the end portions of the resiliently flexible clip.

23. The replaceable razor cartridge of claim 17, wherein the cartridge comprises guide surfaces configured to guide the pins of the handle connecting structure into the through holes.
